(19) United States
(12) Patent Application Publication
(10) Pub. No.: US 2019/0184947 A1
(43) Pub. Date: Jun. 20, 2019

(54) MOTORCYCLE CLEANING TOWEL

(71) Applicant: Paul R. Moreno, Ladd, IL (US)

(72) Inventor: Paul R. Moreno, Ladd, IL (US)

(21) Appl. No.: 15/844,605

(22) Filed: Dec. 17, 2017

(51) Int. Cl. B60S 3/04; B60S 1/56; B08B 1/00; B08B 3/08

(52) U.S. Cl. CPC B60S 3/045; B60S 3/041; B08B 3/08; B08B 1/006; B60S 1/56

(57) ABSTRACT

A towel for washing a motorcycle includes an upper portion configured to overlie at least a portion of the motorcycle windshield and a lower portion configured to overlie at least a portion of the motorcycle fairing. An upper pocket of the upper portion is configured to receive the top of the motorcycle windshield, a left side pocket of the lower portion is configured to receive a left side portion of the motorcycle fairing, and a right side pocket of the lower portion is configured to receive the right side portion of the motorcycle fairing. The towel may be soaked in a cleaning fluid and is configured such that it can be positioned on the windshield and fairing and will remain there without any intervention required by a user. The user may therefore leave the towel unattended to soak on the windshield and fairing, thereby allowing sufficient time for the cleaning solution to soften debris on the windshield and fairing to make it easier to remove the debris.

### BACKGROUND

The present disclosure relates cleaning implements and, more specifically, to a towel configured to facilitate the cleaning of motorcycle fairings and windshields

As appreciated by motorcycle riders, bugs, dirt, and road grime that accumulate on motorcycle fairings and windshields during a ride can be extremely difficult to remove. While a variety of special cleaners are available to assist in the cleaning process, many of these cleaners are relatively harsh, and may discolor the windshield or damage the finish of the fairing when used repeatedly over time. These cleaners often also require vigorous scrubbing of the fairing and windshield with a towel or cloth to be effective, which can lead to unsightly scratching or swirl marks in the windshield or finish of the fairing.

### SUMMARY

In some aspects, a towel for washing a motorcycle is provided and is configured to at least partially cover forwardly facing surfaces of a motorcycle windshield and a motorcycle fairing. The towel includes an upper portion configured to overlie at least a portion of the motorcycle windshield. The upper portion defines an upper pocket configured to receive the motorcycle windshield. The towel also includes a lower portion configured to overlie at least a portion of the motorcycle fairing. The lower portion defines a left side pocket configured to receive a left side portion of the motorcycle fairing, and a right side pocket configured to receive a right side portion of the motorcycle fairing. The lower portion further defines a lower edge having a lower edge profile that substantially corresponds to a lower boundary of the motorcycle fairing when the upper pocket receives the motorcycle windshield, the left side pocket receives the left side portion of the motorcycle fairing, and the right side pocket receives the right side portion of the motorcycle fairing.

The upper pocket may define a pocket depth and a pocket width, and the pocket width may be at least three times greater than the pocket depth. The towel may define a height direction extending generally between the upper pocket and the lower edge. The left side pocket and the right side pocket may each define a side pocket upper edge, the upper pocket may define an upper pocket lower edge, and the upper pocket lower edge may be spaced in the height direction from the side pocket upper edges. The upper pocket may define an upper pocket depth, and the upper pocket lower edge may be spaced in the height direction from the side pocket upper edges by a distance that is at least two times the upper pocket depth. The upper portion may be formed separately from the lower portion. The towel may further include a seam extending generally between the left side pocket and the right side pocket and joining the upper portion to the lower portion. The upper portion may include an upper edge having a first end and a second end. The first end may be substantially adjacent to an inner upper corner of the left side pocket, and the second end may be substantially adjacent to an inner upper corner of the right side pocket. The lower edge profile may be substantially W-shaped. The lower portion may be defined by a lower panel. Each side pocket may include an upper pocket edge joined to the lower panel, an outer pocket edge joined to the lower panel, an inner pocket edge that is not joined to the lower panel, and a lower pocket edge that is not joined to the lower panel. Each side pocket may be closed in upward and outward directions and opened in inward and downward directions.

In other aspects, a method of washing a motorcycle is provided and includes providing a towel having an upper portion defining an upper pocket, and a lower portion defining a first side pocket and a second side pocket. The second side pocket is positioned substantially opposite the first side pocket. The towel is soaked in a cleaning solution and an upper portion of the motorcycle is inserted into the upper pocket. A first side portion of the motorcycle is inserted into the first side pocket, and a second side portion of the motorcycle that is positioned substantially opposite the first side portion is inserted into the second side pocket to thereby support the towel from the motorcycle with the towel positioned to contact forwardly facing surfaces of the motorcycle.

Time may be allowed to pass while the cleaning solution softens debris on the forwardly facing surfaces. The towel may be removed from the motorcycle, and the towel may be used to scrub the forwardly facing surfaces. The motorcycle may include a windshield, and inserting the upper portion of the motorcycle into the upper pocket may include inserting at least a portion of the windshield into the upper pocket. The motorcycle may include a fairing, and inserting the first side portion of the motorcycle into the first side pocket may include inserting a first side portion of the fairing into the first side pocket, and inserting the second side portion of the motorcycle into the second side pocket may include inserting a second side portion of the fairing into the second side pocket. The fairing may have a lower boundary and the lower portion may include a lower edge having a lower edge profile. The method may further include substantially aligning the lower edge profile to the lower boundary in response to inserting the upper portion of the motorcycle into the upper pocket, inserting the first side portion of the motorcycle into the first side pocket, and inserting the second side portion of the motorcycle into the second side pocket.

In other aspects, a towel for washing a motorcycle is provided and is configured to at least partially cover forwardly facing surfaces of a motorcycle windshield and a motorcycle fairing. The towel includes an upper portion configured to overlie at least a portion of the motorcycle windshield and including an upper edge having a first end and a second end. The upper portion defines an upper pocket configured to receive the motorcycle windshield. A lower portion of the towel is configured to overlie at least a portion of the motorcycle fairing. The lower portion defines a left side pocket configured to receive a left side portion of the motorcycle fairing, and a right side pocket configured to receive a right side portion of the motorcycle fairing. The first end of the upper edge is substantially adjacent to an inner upper corner of the left side pocket, and the second end of the upper edge is substantially adjacent to an inner upper corner of the right side pocket.

The lower portion may define a lower edge having a lower edge profile that substantially corresponds to a lower boundary of the motorcycle fairing when the upper pocket receives the motorcycle windshield, the left side pocket receives the left side portion of the motorcycle fairing, and the right side pocket receives the right side portion of the motorcycle fairing. The upper pocket may define a pocket depth and a pocket width, and the pocket width may be at least three times greater than the pocket depth. The lower portion may be defined by a lower panel, and each side pocket may include an upper pocket edge joined to the lower panel, an outer pocket edge joined to the lower panel, an inner pocket edge that is not joined to the lower panel, and a lower pocket edge that is not joined to the lower panel. Each side pocket may be closed in upward and outward directions and opened in inward and downward directions.

### BRIEF DESCRIPTION OF THE DRAWINGS

FIG. 1 is front perspective view of a portion of a motorcycle with an exemplary embodiment of a cleaning towel draped over the motorcycle windshield and fairing.

FIG. 2 is rear perspective view of the fairing and handlebar area of the motorcycle illustrated in FIG. 1, with the cleaning towel draped over the motorcycle windshield and fairing.

FIG. 3 is side perspective view of the fairing and handlebar area of the motorcycle illustrated in FIG. 1 with the cleaning towel draped over the motorcycle windshield and fairing.

FIG. 4 is a back view of the cleaning towel illustrated in FIG. 1.

Before any embodiments of the invention are explained in detail, it is to be understood that the invention is not limited in its application to the details of construction and the arrangement of components set forth in the following description or illustrated in the accompanying drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

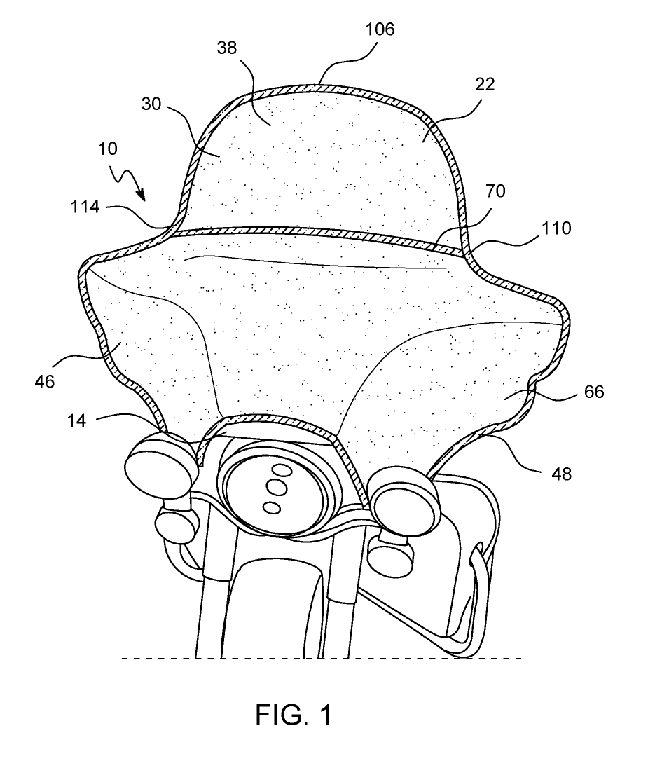

FIGS. 1-3 illustrate a cleaning towel 10 for a motorcycle. In FIGS. 1-3, the cleaning towel 10 is draped over and covering forwardly facing surfaces of a combination fairing 14 and windshield 18 of a motorcycle. In the illustrated example, the cleaning towel 10 is configured, in the manner described further below, to fit over the fairing 14 and windshield 18 of a Harley-Davidson® brand motorcycle having what is often referred as a “Batwing” style fairing 14. It should be appreciated, however, the that teachings and insights provided herein may also be applied by those skilled in the art to design, develop, and use alternative embodiments of cleaning towels 10 for use with other brands of motorcycle and other styles of fairings, including sportbike fairings, enduro fairings, café fairings, and the like. Moreover, while the illustrated towel 10 is configured to cover substantially all of the forwardly facing surfaces of the fairing 14 and windshield 18, alternative designs may not necessarily cover all such forwardly facing surfaces and in that regard may only partially cover such forwardly facing surfaces.

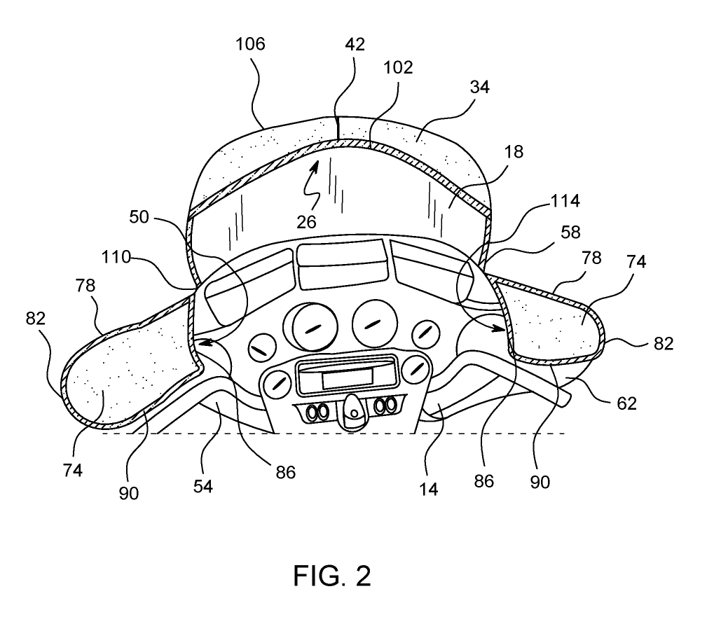

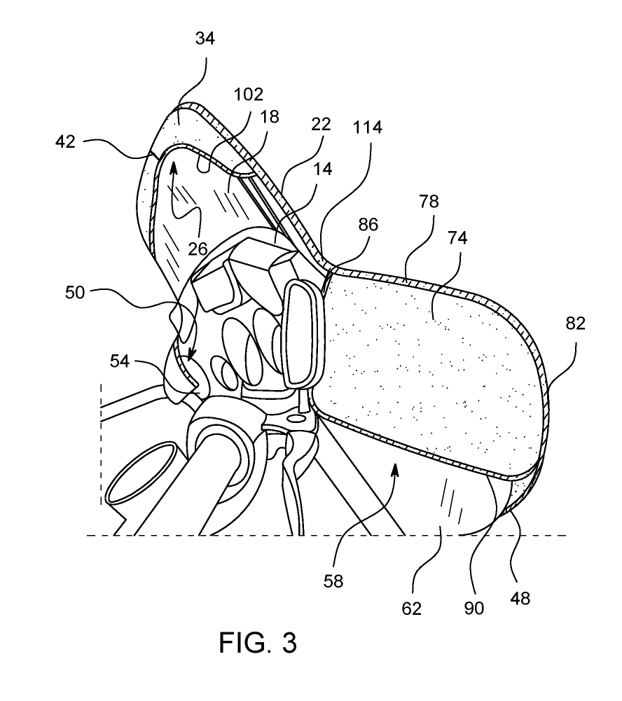

The illustrated towel 10 includes an upper portion 22 configured to overlie at least a portion of the motorcycle windshield 18. As best shown in FIG. 2, the upper portion 22 defines an upper pocket 26 that is configured to receive the upper-most portion of the motorcycle windshield 18. The upper portion 22 is defined by an upper panel 30 of material. The upper pocket 26 in the illustrated example is formed by folding the upper panel 30 in a rearward direction (with respect to the orientation of the towel 10 when positioned on a motorcycle) to define a folded portion 34 (FIGS. 2-3) and an unfolded portion 38 (FIG. 1) of the upper panel 30, and then stitching or otherwise securing the folded portion 34 to the unfolded portion 38 to define the upper pocket 26. In the illustrated configuration, a centrally located dart 42 is provided to help contour the upper pocket 26 shape to the curved upper edge of the windshield 18.

The illustrated towel 10 also includes a lower portion 46 configured to overlie at least a portion of the motorcycle fairing 14. The lower portion has a lower edge 48 defining a lower edge profile that substantially corresponds to a lower boundary of the motorcycle fairing 14 when the towel 10 is draped over the windshield 18 and fairing. Although the illustrated configuration does not extend to cover the motorcycle headlight (see FIG. 1), other embodiments may be provided with a lower edge profile and/or an additional panel of material to cover the motorcycle headlight to facilitate cleaning thereof in the manner described below with respect to the fairing 14 and windshield.

As best shown in FIG. 2, the lower portion 46 defines a first/left side pocket 50 that is configured to receive a first/left side portion 54 of the motorcycle fairing 14, and a second/right side pocket 58 substantially opposite the left side pocket 50 and configured to receive a second/right side portion 62 of the motorcycle fairing 14. In the illustrated embodiment, the lower portion 46 is formed separately from the upper portion 22 and is defined by a lower panel 66 of material that may or may not be the same as the material used in the upper panel 30. As shown, the upper portion 22 and the lower portion 46 may be joined to one another by a seam 70 that extends generally between the left side pocket 50 and the right side pocket 58. The material used in one or both of the upper portion 22 and the lower portion 46 may be or include terry-cloth, chamois, micro-fiber, or any other fabric suitable for use in the cleaning of automotive-grade finishes.

Depending on the specific configuration, the left side pocket 50 and the right side pocket 58 may be formed, for example, by cutting the lower panel 66 to create a desired shape of side pocket panels 74 and then folding the side pocket panels 74 to form the left and right side pockets 50, 58. Alternatively, the left and right side pockets 50, 58 may be formed by individually cutting out separate side pocket panels 74 and sewing or otherwise securing the side pocket panels 74 to the lower panel 66 to define the left and right side pockets 50, 58.

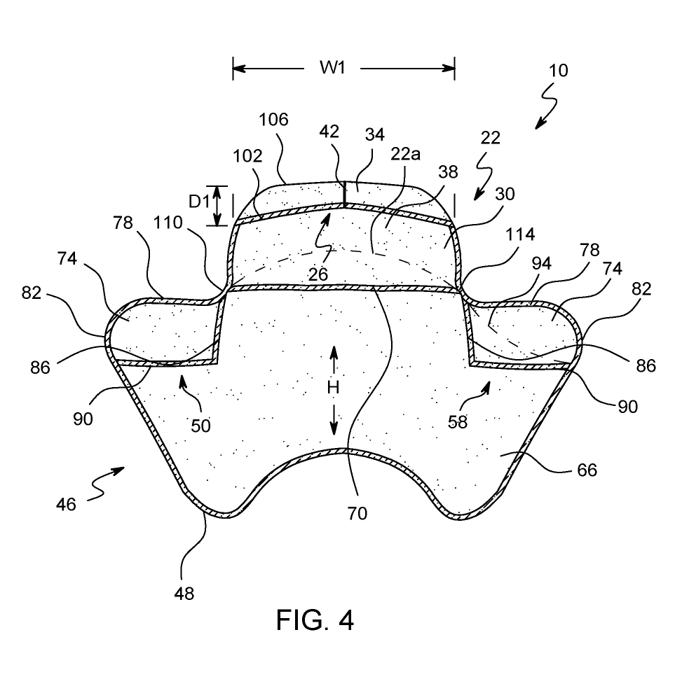

In the illustrated example, each side pocket 50, 58 is formed to include an upper pocket edge 78 that is joined to the lower panel 66 and an outer pocket edge 82 that is joined to the lower panel 66. Each side pocket 50, 58 is also formed to include an inner pocket edge 86 that is not joined to the lower panel 66, and a lower pocket edge 90 that is also not joined to the lower panel 66. In alternative embodiments, one or both of the side pockets 50, 58 may be provided with a single inner-lower edge 94 (see dashed line in FIG. 4) that extends generally diagonally between the upper pocket edge 78 and the outer pocket edge 82. In either case (separate inner pocket edge 86 and lower pocket edge 90 or single inner-lower edge 94), each side pocket 50, 58 is configured such that it is closed in the upward and outward directions and opened in the inward and downward directions. In the illustrated embodiments this is achieved by having the side pocket panel 74 attached to the lower panel 66 at the upward and outward extremities of the side pocket panel 74, and not attached to the lower panel 66 at the inward and downward extremities of the side pocket panel 74. Having the pockets 50, 58 configured in this manner may facilitate inserting the left side portion 54 of the motorcycle fairing 14 into the left side pocket 50 and inserting the right side portion 62 of the motorcycle fairing 14 into the right side pocket 58, as discussed further below.

Those skilled in the art will recognize the side pockets 50, 58 can be formed in many ways. For example, the upper pocket edge 78, the outer pocket edge 82, or both may be formed by appropriate cutting, folding, and/or stitching of the lower panel 66 and/or the side pocket panel. The upper pocket edge 78, outer pocket edge 82, inner pocket edge 86, lower pocket edge 90, and/or the single inner-lower edge 94 may be straight, curved, or combinations of straight and curved sections.

Referring also to FIG. 4, which shows the towel 10 positioned on a substantially flat surface, the towel 10 defines a height direction H extending generally between the upper pocket 26 and the lower edge 48 of the lower portion 46. The upper pocket 26 defines an upper pocket lower edge 102, and the upper pocket lower edge 102 is spaced in the height direction from the upper pocket edges 78. In alternative embodiments, the spacing in the height direction of the upper pocket lower edge 102 and the upper pocket edges 78 may be adjusted to accommodate windshields 18 of varying heights. For example, the windshields 18 of the illustrated Batwing style motorcycle fairing 14 are known to come in 3 heights. The embodiment shown in solid lines in FIG. 4 is configured for the tallest of these windshields while the dashed line 22a in FIG. 4 depicts the general outline of the upper portion 22 for the shortest of these windshields 18. The medium height windshield will be accommodated by upper portion 22 having an upper pocket 26 located generally between the solid line and dashed line depictions shown in FIG. 4.

Referring again to the illustrated embodiment, the upper pocket 26 defines an upper pocket depth D1 and an upper pocket width W1, and the pocket width W1 is at least about three times greater than the pocket depth D1. This configuration has been found to provide suitable support in the vertical direction for the towel 10 when the towel 10 is draped over the fairing 14 and windshield 18, without leaving an excessive amount of material positioned behind the windshield, where cleaning solution soaked into the material might otherwise drip onto the gauges and electronics. In the illustrated embodiment, the upper pocket 26 configuration results in the upper pocket lower edge 102 being spaced in the height direction from the upper pocket edges 78 by a distance that is at least two times the pocket depth D1.

The upper portion 22 includes an upper portion upper edge 106 having a first end 110 and a second end 114. The upper portion 22 is configured and arranged such that the first end 110 is substantially adjacent to the inner upper corner of the left side pocket 50, and such that the second end 114 is substantially adjacent to an inner upper corner of the right side pocket 58. As is apparent from the dashed line 22a in FIG. 4, this characteristic may be shared by different embodiments of the towel 10 that may be configured for use with different types, styles, or sizes of fairings 14 and/or different types, styles, or sizes of windshield 18.

FIG. 4 also shows the lower edge profile defined by the lower edge 48, which in the illustrated embodiment is substantially W-shaped. As mentioned above and illustrated in FIG. 1, the lower edge profile is configured to substantially correspond to a lower boundary of the motorcycle fairing when the towel 10 is draped over the fairing 14 and windshield 18, including when the upper pocket 26 receives the top of the motorcycle windshield 18, when the left side pocket 50 receives the left side portion 54 of the motorcycle fairing 14, and when the right side pocket 58 receives the right side portion 62 of the motorcycle fairing 14.

Depending on the configuration of the fairing 14, windshield 18, and towel 10, the lower portion 46 may cover some or all of the windshield 18, and the upper portion 22 may cover some or all of the fairing 14. In some configurations, there may not be distinct upper and lower portions 22, 46 of the towel 10, for example because the upper portion 22 and the lower portion 46 are formed from the same piece of material. Moreover, the size, shape, and relative locations of the upper pocket 26 and the left and ride side pockets 50, 58 may also vary considerably, as may the specific shape of the lower edge profile defined by the lower edge 48, all of which may be configured by those skilled in the art to correspond to a particular style of fairing and/or windshield.

The towel 10 and alternative embodiments thereof are configured for use in connection with a method of washing a motorcycle, and more specifically a method of washing the motorcycle fairing 14 and windshield 18. To wash the motorcycle fairing 14 and windshield 18 using the towel 10, the towel 10 may initially be soaked in a cleaning solution. The cleaning solution may be or include any suitable liquid cleaning solution including plain water, water and soap, or the like. When the towel 10 is wet, an upper portion of the motorcycle, such as the upper portion of the windshield 18, is inserted into the upper pocket 26 such that the upper portion 22 and lower portion 46 of the towel 10 fall generally over the forwardly-facing surfaces of the windshield 18 and fairing 14. A first side portion of the motorcycle, such as the left side portion 54 of the fairing 14, may then be inserted into a first side pocket, such as the left side pocket 50, of the towel 10. This may be accomplished by inserting the left side portion 54 of the fairing 14 through the opening defined by the inner pocket edge 86 and lower pocket edge 90 (or by the single inner-lower edge 94, if the left side pocket 50 is so-configured) of the left side pocket 50. A second side portion of the motorcycle, such as the right side portion 62 of the fairing 14, may then be inserted into a second side pocket, such as the right side pocket 58, of the towel. This may be accomplished by inserting the right side portion 62 of the fairing 14 through the opening defined by the inner pocket edge 86 and lower pocket edge 90 (or by the single inner-lower edge 94, if the right side pocket 58 is so-configured) of the right side pocket 58. It should be appreciated that the order of inserting portions of the motorcycle into pockets of the towel 10 may be changed without departing from the spirit and scope of the invention, although in many instances it may be beneficial to begin by inserting the windshield 18 into the upper pocket 26.

With the motorcycle portions inserted into their respective pockets, the upper and lower portions 22, 46 may be adjusted as necessary with respect to the windshield 18 and fairing 14 such that the upper and lower portions 22, 46 are in substantially continuous contact with the forwardly facing surfaces of the windshield 18 and fairing 14. Although some smoothing of the towel 10 may be required, and although some overhang (up to several inches) is possible and may even be preferred to ensure full coverage of the fairing 14, when the upper portion (e.g., the windshield 18) of the motorcycle is inserted into the upper pocket 26, the left side portion 54 is inserted into the left side pocket 50, and the right side portion 62 is inserted into the right side pocket 58, the configuration of the towel 10 is such that the lower edge profile defined by the lower edge 48 of the towel 10 is substantially corresponds with the lower boundary of the motorcycle fairing 14 (see FIG. 1). If the lower edge profile is carefully formed to minimize overhang, the lower edge profile of the lower edge 48 may also become substantially aligned with the lower boundary of the motorcycle fairing 14 when the upper portion (e.g., the windshield 18) of the motorcycle is inserted into the upper pocket 26, the left side portion 54 is inserted into the left side pocket 50, and the right side portion 62 is inserted into the right side pocket 58

When positioned on the windshield 14 and fairing 18 as described above, the weight and configuration of the towel 10 bring the towel material and the cleaning solution it carries into direct contact with debris (bugs, dirt, grime, and the like) present on the forwardly facing surfaces of the windshield 14 and fairing 18. Because of its configuration, the towel 10 can remain supported by the windshield 14 and fairing 18 without any intervention required by a user. The user may therefore leave the towel to soak on the windshield 14 and fairing 18 unattended, allowing time to pass while the cleaning solution works to soften the debris. The specific amount of time required depends upon a variety of factors such as the cleaning solution used and how soiled the windshield 14 and fairing 18 are to begin with, but 15-30 minutes are typically sufficient. When sufficient time has passed, the towel 10 can be removed, may optionally be rinsed and soaked once again in cleaning fluid, and then used to wipe the forwardly facing surfaces of the fairing 14 and windshield 18. Because the cleaning solution has had sufficient time to soften the debris on these surfaces, it is relatively easy to remove the debris using the cleaning-solution-containing towel 10 without the use of vigorous scrubbing that might otherwise damage the windshield 18 or the cosmetic finish on the fairing 14. Once the softened debris has been removed the towel may be hand or machine washed and dried, after which it will be ready for reuse.

Various features of the invention are set forth in the following claims.

What is claimed is:

1. A towel for washing a motorcycle, the towel configured to at least partially cover forwardly facing surfaces of a motorcycle windshield and a motorcycle fairing, the towel comprising:
an upper portion configured to overlie at least a portion of the motorcycle windshield, the upper portion defining an upper pocket configured to receive the motorcycle windshield; and,
a lower portion configured to overlie at least a portion of the motorcycle fairing, the lower portion defining a left side pocket configured to receive a left side portion of the motorcycle fairing, and a right side pocket configured to receive a right side portion of the motorcycle fairing, the lower portion further defining a lower edge having a lower edge profile that substantially corresponds to a lower boundary of the motorcycle fairing when the upper pocket receives the motorcycle windshield, the left side pocket receives the left side portion of the motorcycle fairing, and the right side pocket receives the right side portion of the motorcycle fairing.

2. The towel of claim 1, wherein the upper pocket defines a pocket depth and a pocket width, and wherein the pocket width is at least three times greater than the pocket depth.

3. The towel of claim 1, wherein the towel defines a height direction extending generally between the upper pocket and the lower edge, wherein the left side pocket and the right side pocket each define a side pocket upper edge, wherein the upper pocket defines an upper pocket lower edge, and wherein the upper pocket lower edge is spaced in the height direction from the side pocket upper edges.

4. The towel of claim 3, wherein the upper pocket defines an upper pocket depth, and wherein the upper pocket lower edge is spaced in the height direction from the side pocket upper edges by a distance that is at least two times the upper pocket depth.

5. The towel of claim 1, wherein the upper portion is formed separately from the lower portion, the towel further comprising a seam extending generally between the left side pocket and the right side pocket and joining the upper portion to the lower portion.

6. The towel of claim 1, wherein the upper portion includes an upper edge having a first end and a second end, wherein the first end is substantially adjacent to an inner upper corner of the left side pocket, and wherein the second end is substantially adjacent to an inner upper corner of the right side pocket.

7. The towel of claim 1, wherein the lower edge profile is substantially W-shaped.

8. The towel of claim 1, wherein the lower portion is defined by a lower panel, wherein each side pocket includes an upper pocket edge joined to the lower panel, an outer pocket edge joined to the lower panel, an inner pocket edge that is not joined to the lower panel, and a lower pocket edge that is not joined to the lower panel.

9. The towel of claim 1, wherein each side pocket is closed in upward and outward directions and opened in inward and downward directions.

10. A method of washing a motorcycle, the method comprising:
providing a towel having an upper portion defining an upper pocket, and a lower portion defining a first side pocket and a second side pocket, the second side pocket positioned substantially opposite the first side pocket;
soaking the towel in a cleaning solution;
inserting an upper portion of the motorcycle into the upper pocket;
inserting a first side portion of the motorcycle into the first side pocket; and
inserting a second side portion of the motorcycle that is positioned substantially opposite the first side portion into the second side pocket to thereby support the towel from the motorcycle with the towel positioned to contact forwardly facing surfaces of the motorcycle.

11. The method of claim 10, further comprising:
allowing time to pass while the cleaning solution softens debris on the forwardly facing surfaces;
removing the towel from the motorcycle; and
using the towel to remove the debris from the forwardly facing surfaces.

12. The method of claim 10, wherein the motorcycle includes a windshield, and wherein inserting the upper portion of the motorcycle into the upper pocket includes inserting at least a portion of the windshield into the upper pocket.

13. The method of claim 12, wherein the motorcycle includes a fairing, wherein inserting the first side portion of the motorcycle into the first side pocket includes inserting a first side portion of the fairing into the first side pocket, and wherein inserting the second side portion of the motorcycle into the second side pocket includes inserting a second side portion of the fairing into the second side pocket.

14. The method of claim 10, wherein the motorcycle includes a fairing having a lower boundary and wherein the lower portion includes a lower edge having a lower edge profile, the method further comprising substantially aligning the lower edge profile to the lower boundary in response to inserting the upper portion of the motorcycle into the upper pocket, inserting the first side portion of the motorcycle into the first side pocket, and inserting the second side portion of the motorcycle into the second side pocket.

15. A towel for washing a motorcycle, the towel configured to at least partially cover forwardly facing surfaces of a motorcycle windshield and a motorcycle fairing, the towel comprising:
an upper portion configured to overlie at least a portion of the motorcycle windshield and including an upper edge having a first end and a second end, the upper portion defining an upper pocket configured to receive the motorcycle windshield; and,
a lower portion configured to overlie at least a portion of the motorcycle fairing, the lower portion defining a left side pocket configured to receive a left side portion of the motorcycle fairing, and a right side pocket configured to receive a right side portion of the motorcycle fairing,
wherein the first end of the upper edge is substantially adjacent to an inner upper corner of the left side pocket, and wherein the second end of the upper edge is substantially adjacent to an inner upper corner of the right side pocket.

16. The towel of claim 15, wherein the lower portion defines a lower edge having a lower edge profile that substantially corresponds to a lower boundary of the motorcycle fairing when the upper pocket receives the motorcycle windshield, the left side pocket receives the left side portion of the motorcycle fairing, and the right side pocket receives the right side portion of the motorcycle fairing.

17. The towel of claim 15, wherein the upper pocket defines a pocket depth and a pocket width, and wherein the pocket width is at least three times greater than the pocket depth.

18. The towel of claim 15, wherein the lower portion is defined by a lower panel, wherein each side pocket includes an upper pocket edge joined to the lower panel, an outer pocket edge joined to the lower panel, an inner pocket edge that is not joined to the lower panel, and a lower pocket edge that is not joined to the lower panel.

19. The towel of claim 1, wherein each side pocket is closed in upward and outward directions and opened in inward and downward directions.
